(19) United States
(12) Patent Application Publication
(10) Pub. No.: US 2005/0146990 A1
(43) Pub. Date: Jul. 7, 2005

(54) System and method for improved retroactive recording and/or replay

(76) Inventor: Yaron Mayer, Jerusalem (IL)

Correspondence Address: YARON MAYER, 21 AHAD HAAM ST., JERUSALEM, 92151, IL

(21) Appl. No.: 10/905,038

(22) Filed: Dec. 13, 2004

Related U.S. Application Data
(63) Continuation-in-part of application No. 10/449,703, filed on Jun. 2, 2003.
(60) Provisional application No. 60/439,999, filed on Jan. 10, 2003.

(30) Foreign Application Priority Data
May 31, 2002 (IL) 149968
Dec. 12, 2003 (CA) 2,451,945

(51) Int. Cl. G04F 1/04; G10H 1/18; G10H 3/12

(52) U.S. Cl. 368/95

(57) ABSTRACT

One of the most frustrating things when recording for example songs from the radio is that many times by the time the user decides that he/she would like to record for example some song, the beginning of the song is already lost. Or the user might zap between radio stations and tune into the station after the song has already started or for example after the beginning of an interesting conversation or message or News item and is frustrated that he missed the beginning of it. Similarly, for example while zapping through cable TV stations, a user might find for example a fascinating scientific program or a fascinating report and regret that he/she had not seen or recorded it from the start for later reference. The idea of retroactive recording and/or replay has existed already since 1990 and there are a number of patents about it, but they do not deal with the problem of enabling retroactive recording and/or replay also when the user is zapping between channels for example on Radio or on TV. The present invention describes an improved system and method for automatic time-shifted retroactive recording or replay, that applies retroactive recording and/or replay also to a situation of switching between channels. Additional improvements and possible implementations are also shown, including for example improved zapping speed which can be used also without retroactive replay/recording.

This patent application is a CIP of U.S. application Ser. No. 10/449,703 of Jun. 2, 2003, hereby incorporated by reference in its entirety, which claims priority from Israeli application 149968 of May 31, 2002 and from U.S. provisional application 60/439,999 of Jan. 10, 2003, hereby incorporated by reference in their entireties.

This patent application also claims priority from Canadian application 2,451,945 of Dec. 12, 2003, hereby incorporated by reference in its entirety.

### BACKGROUND OF THE INVENTION

1. Field of the Invention

The present invention relates to retroactive recoding or replay, and more specifically to an improved system and method for automatic time-shifted retroactive recording or replay, so that when the user requests for example an audio tape recorder or a video tape recorder to start recording, he/she may also request that the recording will be retroactive, i.e. for example to start as if the user had requested it before, for example a few minutes or more earlier or automatically since the beginning of the event. The main improvement over the prior art is applying retroactive recording also to a situation of switching between channels, but additional improvements and possible implementations are also shown.

2. Background

Audio tape recorders and video tape recorders have changed very little during the last 10 years, very unlike what has been going on for example in the computer industry at the same time. Although such devices typically contain already microprocessors and although various forms of immediate access memory are very cheap today, still the state-of-the-art devices have not improved to take better advantage the possibilities that this has opened up already years ago.

One of the most frustrating things when recording for example songs from the radio is that many times by the time the user decides that he/she would like to record for example some song, the beginning of the song is already lost. Or the user might zap between stations and tune into the station after the song has already started or after the beginning of an interesting conversation or message or News item. Similarly, for example while zapping through cable TV stations, a user might find for example a fascinating scientific program and regret that he/she had not seen or recorded it from the start for later reference. Although some video cameras exist that allow the user for example to record the sound a few seconds (typically 6 or 9 seconds) prior to pressing the button (by constantly recording in advance), this is used only to solve some response-time problems of the device itself of a few seconds at most, and not for the much more sophisticated purposes described below. On the other hand, ReplayTV and Tivo for example do allow users instant replay and/or recording from a temporal buffer, however they do not address the issue of recording retroactively while zapping, since at any given time they can keep in the temporary buffer only the current station that the user is tuned into or a station that the user pre-programmed it to record. The core idea of retroactive recording using a circular buffer, for recording computer events or as a tape-recorder, exists already at least since 1990 and was published in the ICMC 1990 Proceedings, as can be seen at http://xenakis.ircam.fr/articles/textes/Smith90a/. The idea of retroactive recording of images in a Video camera is also mentioned for example in a University-of-Toronto publication at http://about.eyetap.org/faq/blfaq3.shtml, however the exact date of first publication of that is not clear. In addition, there are a number of patents from the recent few years which deal with retroactive recording on a computer or tape recorder or video recorder, typically with a digital circular buffer. U.S. Pat. No. 5,845,240, issued to Fielder on Dec. 1, 1998, is a very broad patent that includes some very wide claims and seems to ignore the above prior art published in 1990. U.S. Pat. No. 6,064,792, issued on May 16, 2000 to Fox et. al. also seems to ignore the above prior art. It does refer to recording multiple signals that are part of the same channel (for example stereo sound), but does not refer to multiple channels, which involves different problems. U.S. Pat. No. 6,072,645, issued to Sprague on Jun. 6, 2000, refers to retroactive recording mainly on audio tape recorders, however he does not refer to the problem of identifying for example when the event began in order to be able to jump directly to it's beginning instead of just back an arbitrary amount of time. U.S. Pat. No. 6,263,147, issued to Sun Microsystems on Jul. 17, 2001, adds the concept of automatically detecting the beginning and/or ends of events, which is of course important in order to enable the user to jump back automatically to the beginning instead of just an arbitrary amount of time or having to search for the beginning manually. That patent also describes for example retroactive recording of an unexpected event on a Video camera but ignores completely the fact that most likely the camera will not have been directed at the event, so the retroactive recording may be useless. U.S. Pat. No. 6,378,035, issued to Microsoft on Apr. 23, 2002, refers more generally to streaming data and various optional additional manipulations on them. However, to the best of my knowledge, non of the previous patents address the issue of simultaneously covering multi-channels, so that the retroactive recording can work also for example while the user is zapping between channels, for example on Radio or on TV, or covering for example multiple directions when a video camera is involved. Clearly more powerful and flexible retroactive recording and/or replay systems and methods are needed.

### SUMMARY OF THE INVENTION

The present invention tries to enable users the power and flexibility in retroactive recording and/or replay that are needed as described above. Many possible variations are shown and various problems are discussed and solved.

In computers the solution for allowing retroactive recording or replay is preferably to use a software that preferably always records for example the audio line-in, preferably in one or more circular buffers, so that at each point in time the user can take advantage of the temporary buffer, which can extend for example 15 or 30 minutes into the past (or any other convenient and reasonable time frame). Preferably the user defines in advance the size of the circular or temporal buffer, for example in minutes. Preferably the program auto-loads automatically whenever the user starts the computer, so that the user does not have to worry about forgetting to start the pre-recording. The recording itself can be for example on one large temporary file on the hard-disk (or other type of preferably non-volatile memory) or for example on a number of temporary files, divided for example according to constant time slices, or for example by automatic dividing into songs, for example by identifying various waveform clues for the borders between songs, such as for example silences between the songs, or for example by using a broadcasting method that includes for example data about the start and/or end of events and preferably also the identification of the item (for example the type and/or the name of the item), for example: Event Type: Song, Sub-Category: Blues, Name: “Killing me softly”), such as for example RDS (Radio Data System) or any other coding method, for example with normal radio or TV or when broadcasting over the Internet or cellular networks. The recording can be for example in raw form, or for example with some automatic compression, such as for example MP3, which can be easily done on-the-fly for example with a Pentium of 1 GHz or more, or can be for example included in a preferably dedicated DSP (digital Signal Processing) unit, for example within the sound card. Another possible variation is for example that the conversion to MP3 (or other convenient compression format) is done only when the user decides to save an event, which consumes therefore CPU power only when needed. If the songs are automatically divided into files, when the user requests to retroactively record a given song from the beginning, one possible variation is that the system simply takes the file already designated for that song, and as soon as the recording ends, the system for example simply asks the user to rename the file to whatever the user wants and/or if to save the file. Another possible variation is to use for example RDS signals, when these are available (or any other type of digital data which might be used by the transmitters), for the automatic division of songs into files in advance and/or for automatic renaming of the files into the appropriate song names, so for example each song is automatically saved in a temporary directory and/or temporary file with the song's name, and if the user wants to save it the file is simply moved to a permanent directory. Another possible variation is to use for example RDS signals in order to automatically skip for example talking sections or commercials. If the signal comes from an external radio then the RDS signal can be transmitted to the computer for example through an RS232 connection or any other connection that will be used for this in the future or can be encoded for example within the audio signal itself, especially for example if it is digital radio. If the listening is for example to Online radio broadcasts on the Internet, then the RDS signals are preferably included in the streaming audio data itself or in additional data transmitted from the site concurrently. Another possible variation is to allow the user for example to request automatic volume normalization so that all songs are preferably automatically set to more or less the same sound level, which is preferably maximized according to the highest waves, for example as an automatic adjustment upon ending the recording of the song, and/or automatically during playback, or for example automatically when the user requests to save a song in long-time storage. To the best of my knowledge there are currently no MP3 encoding or playback programs which use automatic volume normalization. Of course, various combinations of the above and other variations are also possible.

To allow retroactive recording and/or playback while zapping between channels preferably the computer includes also a multi-tuner system for example on the sound card or on a separate card, so that for example the user can choose a given set of channels (for example up to 5 or up to 8 channels) to cover, and then the computer simultaneously records all the selected channels into one or more temporal buffers or for example separate directories. This means that for example instead of one FM decoding chip there are for example 8 such chips, which can all work simultaneously and preferably be recorded on the computer simultaneously. Another possible variation is for example saving on the computer the entire FM band or one or more desired slices of it (or whichever band is used), preferably digitally, so that only if the user requests them later the signals are decoded from the carrier waves. (The FM band or other band or the slice or slices of it can be for example received directly by a radio-receiver card on the PC or for example transferred to it directly from an external radio receiver). Preferably this is done with the aid of down-conversion of the signal, so that for example if the needed range is 93 MHz up to 104 MHz, then the entire band is converted for example to 1-8 MHz, so that it can be saved efficiently for example at a digital sampling rate of 20 MegaBytes per second. This way the user is not limited to a small number of channels. Preferably this is done for example by using various combinations of one or more bandwidth filters and/or for example changeable bandwidth filters.

In an audio tape recorder (preferably one coupled to or including a radio receiver) this can be done similarly, including for example the automatic splitting into separate songs and/or for example the automatic MP3 digital recording on the fly (which can be also based for example on a dedicated DSP chip for this), at least in some of the embodiments. Preferably the temporary buffer is kept for example in MRAM (magnetic RAM) or normal RAM or Flash RAM, or any other convenient preferably immediate-access memory device, however it is also possible is some embodiments to add for example a hard-disk to the tape. Another difference is that since the final output medium in a tape recorder is typically a tape cassette, once the user requests for example to retro-record a song that has already started, the system has a problem of synchronizing the circular buffer with the cassette. One possible variation is that the system in this case waits until the song has finished and only then starts recording it physically to the tape. Another possible variation is that (at least if the song has not started too long ago) the system can use variable recording speeds in order to put the song on the tape at faster rates, so that for example by the time the song has ended the cassette is already synchronized in full-time to the present (in other words the tape catches-up before the song is over, so the cassette can rest as soon as the song is over). Another possible variation (both in the computer version and in the audio-tape version) is that during the recording the user has the choice for example to either hear the song from the present point till the end, or for example to hear it from the beginning of the pre-recording, so that for example from the moment the user requests to start retro-record, he/she can hear the song from the start, as if it has just started. Preferably in this case, the system clearly indicates to the user that he/she is “listening to the past” and preferably also how long ago in the past, so that he/she does not forget this and become confused with real-time listening. Also, in this case, preferably when the song or event ends, or whenever the user requests, the system asks the user if he/she wants to switch back to real-time, and then preferably the user can for example fast-forward into the present (for example by fast discrete jumps, each time hearing a brief normal sound sample of that point in time, or for example by replay at higher speeds) or jump directly into the present, for example especially during non-interesting sections. Also, if the user for example misses a beginning of a subsequent song while still listening in this delayed playback or during the shift back to real-time, preferably the user can still retro-record any required song, as long as the maximum time-window has not been exceeded. Of course such features can be used also without recording, so that for example the user can hear a song back from the start even without recording it, and/or for example decide only afterwards if he/she also wants to record it. This might be useful for example in a car radio when the user for example is distracted by something and wants to preferably instantly replay or retro-record a song or a message or replay the news for example if he/she was distracted during part of the news broadcast. Another possible variation is to record the data on the cassette digitally instead of analogically, which offers more flexibility and reliability, and in this case it can be either raw data, or compressed on the fly, for example into MP3 format. If no automatic division into songs is used, then when the user requests to retro-record he/she can for example request a certain safe-time backwards or request a replay for example from 2 minutes ago and start the actual recording for example when he/she hears the previous song end. Of course various combinations of the above and other variations are also possible.

Another possible variation is to use this also with multiple stations/channels, so that for example the user can define a time window of for example up to 15 minutes for a chosen set of stations/channels (for example if the radio receiver has 8 FM tuner/decoder chips and a memory for 8 possible programmed stations then the user may choose to automatically cover all of them or some of them), or for example the entire typical FM band (or one or more needed subsections from it) without limitations (although that could require much more memory, this is still manageable, especially if the time-window is limited for example to just a few minutes or for example up to 30 minutes, but memory will become even more powerful and cheaper in the next few years, so this will not be a problem anyway). If for example multiple tuners/decoders are used, one possible variation is that these are normal tuner circuits. Another possible variation is for example to use cheaper chips that are for example only decoders of the signals out of the carrier waves or tuners which do not include some features such as for example Stereo separation, so that this is done only later if the data from that channel is selected for replay or saving (however, if for example on-the-fly MP3 compression is used, then all the required processing is preferably done in advance). Anyway, using multiple-tuners/decoders has the further advantage that multiple events can be easily recorded simultaneously if the user is interested in more than one event occurring at the same time. Another possible variation is to allow the user for example to define different time windows for each of the selected channels, so that for example more favorite stations receive larger time-windows. Another possible variation is that the bandwidth itself or one or more sections of it are saved in the temporary buffer, and in that case saving more than one event means that preferably a processor with time-sharing can extract more than one channel within the time window and save it before the buffer is overwritten, (However it can be done of course even without time sharing if the length of the saved items is shorter than the time window, since then processor can save them for example one after the other). Of course it is also possible to use some combination so that for example both the bandwidth or one or more subsections of it can be saved and also more than one tuner is available within the system. If for example the entire FM band or one or more slices of the band are recorded in the temporary buffer then they are preferably saved after down-conversion to lower frequencies as described above and are preferably demodulated from the carrier waves only if needed later. However this can work similarly also with carrier-free broadcast, for example various pulse-based broadcasts, if such broadcasts will be used in the future, and/or for example with audio and/or video streams transmitted through the Internet or for example through broadband cellular networks, such as for example 3G or higher cellular networks. The automatic pre-recording with the preferably circular buffer can be implemented for example in the tape-recorder itself or in the Radio-receiver, or in some integrated system which contains both the Radio-receiver and the tape. However, if retroactive recording and/or replay while zapping between multiple channels are allowed, if it is implemented within the tape it means that the tape preferably includes also tuner capabilities, so more preferably it is a feature of the radio device. Also, preferably the recording into the temporary buffer is done also when the device is off, so that the retro-recording and replay features are available also when the user first starts the device. However, when this is for example a car radio, this can lead to drainage of the car battery after sufficient time, so if the car radio is always recording into the circular buffer even when not using the car then preferably the car can for example automatically activate the engine for example for a few minutes after the battery is low below a certain threshold (for example after many hours), in order to recharge the battery. Another possible variation is that for example the user can program the device to be recording into the circular buffer in off-mode only during certain hours (for example only during daytime), and/or for example the system automatically keeps statistics of the main times that the user activates the device and automatically activates it to record in off-mode only in the relevant times where it is most likely that the user might need it. Another possible variation is that the automatic recording into the circular buffer automatically starts for example when the user enters the car and/or starts the engine, and preferably stops after the user has turned off the radio and/or turned off the engine. Another possible variation is that the ongoing recording into the circular buffer is voice-activated so that preferably only a small sensor that consumes even less power is constantly working all the time. Although U.S. Pat. No. 6,588,015, issued on Jul. 1, 2003 to General Instrument Corporation (filed Jan. 14, 1998, and published also as PCT application WO9937045 on Jul. 22, 1999) also refers to the possibility of using retroactive replay when switching between more than one channel, it refers to it only in the context of digital radio (or digital video) but does not solve the problem of enabling it for example with normal radio broadcasts. (Also, it refers only to replay but not to retroactive recording). On the other hand the above patent adds also another interesting idea: The possibility that the digital radio (or video) station will broadcast the data at a faster than the normal listening rate, so that the user can skip forward to the next track (for example to the next song) while listening in real-time. They also mention the possibility that the same data will be broadcast both at a faster rate and at the real-time rate, so that the receiver can switch between the two modes. However this last claimed feature has the following problems: 1. First of all, the ability to skip forward while receiving the data has already existed on the Internet for quite some time, for example when listening to an audio clip or video clip, for example with the Quicktime player, because the data is typically received at the fastest rate possible, which is typically more than the real-time playback rate, and so while the user listens in real-time the data that has already come-in goes beyond the “present” point and so the user can for example move the play bar forward and thus skip forward to a part that has not been reached yet in the normal listening rate. 2. However, when sending data in a faster than real-time rate for example with a satellite digital radio or an Internet digital radio there is a severe problem which they did not solve, which makes this feature unworkable (in other words not enabled) in practice as they describe it: Simply broadcasting the data as a faster rate has the problem that the disparity between the real-time broadcast and the faster-rate broadcast will simply go bigger all the time, and also starting to receive the data at a certain point for example in the middle of a program would lose more than the first half. For example if such a radio receiver starts receiving data from a digital radio satellite in the middle of a 1-hour program that started for example at 12:00 PM, and the faster-then-normal rate is for example twice the normal rate, then this means that at 12:30 the faster broadcast has already finished the entire program and so cannot be used at all, and even if for example the same broadcast is also available at real-time rate, then at this point only the normal-rate broadcast can be used and thus the skip-forward feature is unavailable at least till the end of the program. In order to really enable the faster-speed broadcasting without these problems, preferably the digital radio and/or video broadcasting system uses a ratio without fractures (for example a ratio of 2:1, 3:1, 5:1, or 10:1, but not for example 1.5:1), and the faster broadcast is preferably repeated automatically during the program again and again, so that for example if a 60 minute broadcast is available in a 12:1 faster-rate (thus within 5 minutes), then preferably it is automatically re-broadcasted in this example 12 times during that hour, and if it is for example available within 2 minutes (at a ratio of 30:1 in this example) then it is preferably re-broadcasted 30 times during the 1 hour program. Another possible variation is that there is no importance for example to the round hour border and/or to program-end borders, and each re-broadcast sends for example the next 60 minutes (or whatever other forward-time window is used) each time, so that for example the first fast 2-minutes broadcast at 12:00-12:02 sends the real broadcast of 12:00-13:00, the 2^{nd} sends between 12:02-12:04 the real data of 12:02-13:02, etc. Another possible variation is that the faster-rate broadcast includes also instead or in addition past data, so that for example the 12:00-12:02 fast broadcast actually sends for example the data of 11:30-12:30 or for example the data of 11:00-12:00). Another possible variation is not to repeat it all the time, so that for example the 2-minute fast broadcast is resent for example only once every 4 minutes, thus leaving for example a 2 minutes gap each time). (Of course the sending of future-data is not possible for example in real-time reporting such as for example when broadcasting live news). This way any time the receiver is starting to listen-in it can preferably catch-up within a few minutes and does not miss the faster transmission just because it started later, and also the retroactive data of for example 30 minutes is available for example within 3 minutes even if the system was not previously recording in the Off-state. Of course, such repeated fast-broadcast wastes more bandwidth, but if for example the satellite has a 3 GigaBit per second bandwidth, and a digital TV channel for example needs 1 MegaBit per second and a digital radio channel for example needs 50 KiloBit per second, then the satellite can easily broadcast for example 3,000 TV channels or 60,000 radio channels simultaneously. In other words, broadcasting for example 100 radio channels at real-time speed and in addition for example in repeat-mode at a ratio of for example 20:1 for example every 3 minutes will be like broadcasting 2,100 radio channels, which requires approximately 105 MegaBit per second, which is just about 3.5% of the satellite's total bandwidth capacity. Since TV is much more bandwidth consuming, in this case preferably the faster rate is preferably considerably lower than with the digital radio, for example just at a ratio of 2:1 or 3:1, and thus repeated for example only 2 time per hour or 3-times per hour respectively. So if for example there are 100 TV channels which are broadcasted for example in real time and in addition for example 3 times per hour in 3:1 ratio, then it is like broadcasting 400 TV channels at normal speed, which means approximately 400 MegaBit per second, which is still just 13.3% of the satellite's total bandwidth capacity in this example. Of course various combinations of the above and other variations are also possible.

For video recording, similar principles can be used, so that for example the videotape recorder can have both a hard-disc (or other types of preferably non-volatile memory, such as for example flash or Magnetic RAM, or other means that will exist in the future) for recording preferably with Random Access capabilities and preferably for example also a socket for ordinary VHS cassettes, for transferring pre-recorded data onto a cassette, and/or means for saving it for example on CD's or DVD's and/or transferring it to a computer. On the other hand, with video-recorders, enabling the user to specify more than one channel for automatic pre-recording for a time window of for example 15 minutes is much more problematic since it requires much more memory than with radio broadcasts. So one possible variation is to include for example up to 5 or 10 or for example up to 20 tuner/decoder circuits in the video recorder, so that the user can for example choose only the 10 or 20 most important channels to be covered like this, and this way each of the chosen channels is preferably covered with pre-recording for the specified time window. So for example instead of 30 or 60 hours for a single channel, the device can retro-record for example simultaneously up to 20 channels each for example up to 3 hours. Preferably the size of the buffer is either automatically divided between the chosen channels, or the user can specify to which channels to give larger buffers, or for example specify a time limit for each channel until the total quota runs out. However, as memory becomes still cheaper and more powerful in the next few years, even for example the entire hyperband for example or at least chosen slices from it (for example sub-ranges of it that cover adjacent channels, or a range that covers the entire channels), preferably in combination with down-conversion, may be recorded as-is for the specified time window, so that it is decoded only if the user later chooses it for retro-recording or retro-viewing. Another possible variation is to digitize for example the entire hyperband or the needed range or slices, and then use digital decoders for extracting the individual channel waves, which are preferably integrated into chips which are therefore cheaper. Another possible variation is to keep the temporal buffer or buffers for example at various transmitting stations along the way or for example at the center of the cable or satellite broadcasting, so that for example any user can request to replay any of the channels for example with a few possible pre-set time-lags of for example jumps of 15 minutes or 30 minutes to choose from (This way many users can tune-in to the same replay simultaneously, thus saving bandwidth). Unlike Radio, for video broadcasting for example in cable TV or satellite this might be less necessary since any user can view the broadcast plan in advance and thus miss less programs, and also many programs are re-broadcasted typically within a day or a few days or a few weeks. However, yet other programs are not broadcasted again, and also the program guides are sometimes very skimpy about certain programs, so that many times the user cannot know in advance that a certain program will be indeed very interesting for him/her, and also for example for various music channels the situation is very similar to listening to songs on the radio, where the user usually does not know in advance which song will be played. Apart from this, all of the above variations described for audio recording may be similarly used also for video recording, including for example compression to MPEG 4 or DIVX or XDIV or any other convenient compression formats (for example on the fly or only when the user requests to save something), preferably with the aid of one or more dedicated DSP. Also, with Cable TV or satellite broadcasts the tendency is more and more to transmit it in digital form, so signals, which are typically already compressed for example in MPEG2 format, can be digitally saved as is in the temporary buffer and when transferred to longer term memory. If an encrypted signal is used, then the system can for example save the data for the covered channels in one or more temporal buffers, preferably as-is, without decoding it, and then for example feed back the desired data to the decoder when needed. Another possible variation is to include for example more than one decoder, but that might require cooperation with the service provider, such as for example the Satellite Broadcasting service or the Cable TV provider. Similarly, of course, when retro-recording for example from a satellite digital radio or other types of digital radio, the data is typically already compressed, so simply the data is preferably saved automatically from the covered channels in the compressed digital format, preferably in one or more circular buffers, and if the data is encrypted and a decoder is needed for decrypting it, then the above solutions regarding use of the decoder can be applied also to digital radios: For example feeding back the encrypted saved data from the circular buffer or buffers to the decoder when needed (for replay and/or recording), or using a device that can preferably decode simultaneously more than one channel on the fly (for example by a CPU or for example dedicated ASIC with time sharing, or by using multiple preferably integrated decoders), and so the data can be saved in the circular buffers already in the decrypted form. But the first of these two options is easier and cheaper to apply and there is no need to decrypt the data while storing it in the circular buffers. In addition, if the data is both compressed and encrypted, it is easier to decrypt it before saving in the circular buffers if the encryption has been done after the compressing, whereas if the encryption is done before the compression or as an integral part of it, then the data might have to be decompressed while decrypted and then compressed again, which makes it even more undesirable to decrypt the data while saving it in the circular buffers. However, it should be kept in mind that Video or radio data that comes for example from a satellite, even if it is digital, can be for example sent over either one frequency on a carrier wave or for example various channels are divided between a number of different frequencies, which means that if more than one frequency is used, preferably multiple tuners are used in the receiver, since using a single tuner that can tune in to different frequencies will typically not be able to switch fast enough between frequencies in order to save in circular buffers at the same time data that belong to channels that are sent on different frequencies. Preferably each tuner at least extracts the digital data for the relevant channel or channels that were requested by the user to be covered for retroactive recording, and this digital data is saved in the temporal buffers (in other words—if for example there are 10 digital channels on each frequency and the user marked 12 channels, 2 of which are on this frequency, then the tuner preferably extracts the data for these 2). Another possible variation in this case, as in some of the above variations, is to save the carrier waves in a range of bandwidths or slices of it. However, if for example a single carrier wave is used and the data for various channels is sent digitally by using time slices then another possible variation is that only a single tuner is needed, but by using this time slicing the digital data for more than one channel can be preferably extracted and saved in the temporary buffers, and thus even though only one tuner is used, there is no need to save the carrier waves themselves. (However, even in such a case the user will typically want to be able to cover also channels from other suppliers simultaneously, so multiple tuners are preferably used anyway). Alternatively, even if a number of frequencies or carrier waves are used for such digital broadcasts, if each frequency or carrier wave contains more than one digital channel then preferably more channels can be covered than the number of tuners, so each tuner preferably can handle at the same time (preferably by time slicing) saving the data from more than one channel in the temporal buffers. Of course if the user wants to cover for example multiple such sources (for example different satellite providers), each of which uses more than one frequency, and each such frequency carrying multiple digital channels, then preferably at least one or more tuners are used for each such source as needed. Of course, if the data is sent for example by fast pulses without a carrier wave, such as for example UWB, then one device might be able to receive multiple frequencies at the same time. Of course, various combinations of the above and other variations can also be used.

Another possible variation, which can be used for example together with any of the other variations, is that the system for example gathers automatically statistics about the user's viewing habits and thus can for example automatically decide which channels to cover automatically for retroactive viewing (so that for example if the system can only cover up to 50 channels simultaneously, it can preferably decide automatically according to the channels which the user spends most time in and/or is most likely to view, which channels to cover) and/or for example what should be the best retroactive time window allocated to each channel (so that for example in channels in which the user typically spends more time and/or in which the typical program size is longer—for example a movie channel compared to a music channel or a channel that deals with news items—preferably the time window is automatically set to longer, so that for example in the music channel, and/or especially for example if the user typically does not spend more than for example 20 minutes consecutively each time on average, than the time window can be for example automatically set to cover by default up to 20 retroactive minutes, and for example in the movies channel the time can be automatically set for example to cover up to for example 1.5 or 2 retroactive hours). Of course this can be done also for example in combination with manual user definitions, so that for example the user can preferably easily view and edit or improve the automatically generated definitions of channels and/or of retroactive window time-length to cover, and/or the user can for example define the channels and/or the time windows initially and then the system for example automatically adjusts it afterwards according to the usage statistics, preferably for example within certain limits, so that for example the system preferably cannot make drastic changes beyond a certain level without warning the user or asking the user for authorization, etc. If multiple users (for example different family members) are using the same device then preferably for example the remote control can allow the user to identify himself/herself (for example by pressing a button that is associated with him/her or entering some code) and/or the user can identify himself/herself by other means (and/or for example some automatic identification can also be used, such as for example by an automatic camera connected to or within the set-top-box or for example other biometric measurements so that for example the system's processor can automatically decide which of the known users is most likely using the system now according to his/her image) and then preferably automatically the user's personal definitions become effective and/or his/her specific statistics are used. Another possible variation is that for example the statistics are used for the entire family on an average basis and/or for example for sub-groups of users with for example similar habits, since otherwise for example if the user gets up and is replaced for example by another family member then for example for the following 30-120 minutes the retroactive data in the buffer might not be good enough for the other user. Another possible variation is that the system also for example takes into account also statistics about the usual times that for example each user typically watches the TV and thus can for example automatically switch the retroactive channels and/or time lengths in advance even for example a certain time before the user is expected to change.

Of course any of the features that are used for retroactive recording can be used also for improved speed of normal zapping, since the problem with zapping in normal digital broadcasts (for example in cable TV or satellite TV) is that the user typically has to wait up to a few seconds till the processor of the set-top-box finds the next base-frame of the new channel and starts decoding the sequence of next frames, which can be quite annoying. So for example when the user zaps into another channel (for example which is already covered for retroactive viewing), the system can preferably automatically supply the last base-frame and its following sequence, so that the system can preferably instantly start showing the video stream of the newly zapped-into channel without any unnecessary delays and without having to wait for the next base frame. Of course, this can be also combined with heuristics based on user behavior statistics, so that for example if the user typically zaps between certain stations in a certain sequence or at least in a certain set or group or sets or groups this can preferably be automatically taken into account even if any of the newly predicted zaps are not currently covered for retroactive recording and/or for example when the user simply zaps forwards or backwards in a sequence then preferably the system automatically generates retroactive recording, even for a short time window of for example a few seconds, for the predicted next jump or jumps (for example according to the user's typical sequences or sets and/or according to the normal consecutive ordered zapping). Another possible variation is to use any of the above features also for example for improved zapping speed for example between channels for example in cable-TV or satellite TV systems even if they are not adapted in general for retroactive viewing/recording. This means that for example the system preferably contains at least 2 or more tuners (especially if for example the satellite or cable service uses a number of different carrier waves for its channels—for example a typical satellite station might use for example 6-8 or more frequencies in which for example each 20 or more digital channels share one of the carrier frequencies, etc.), so that preferably apart from the tuner that is currently used for the currently viewed channel, the other tuner or tuners or at least some of the other tuners can be preferably automatically used to keep track of the base frame and/or its following current frames and/or other needed data stream in the channel or channels which the system predicts that the user is most likely to zap to next. If more then one predicted channel reside on the same base frequency then preferably the system can automatically update multiple buffers at the same time, so that preferably on each frequency the tuner (and/or other elements in the system) can save for example at least 1 or a few second (or more or less, as needed) of data for all the channels of that frequency or at least for the most predicted channels of that frequency, and/or preferably at least the current frame and/or base frame of each channel can preferably be saved there. However, since typically the processors of the tuners need to use time swapping, preferably the buffers each keep for example frames for up to a second or a few seconds so that the processor has time to access them between time sharing jump, and/or for example each tuner has multiple processors and/or for example ASICS which can work in parallel for better efficiency. In addition, preferably the digital channels are arranged in advance by the for example cable or satellite supplier, so that preferably all the channels on each carrier frequency are preferably consecutive (for example channels 1-20 on one carrier frequency, channels 21-40 on the next carrier frequency, etc.), since the user is most likely normally to zap between consecutive or at least near channels, and then this way fewer tuners can be enough for covering multiple predicted next-zap channels. Of course, this means that this way the system might be able to work also with even only one tuner, so that only when the user jumps to a channel at another frequency the wait time will be longer, but preferably, as explained above, the system contains at least one more tuner, preferably with its own processor or processors, so that at least one predicted next-jump can be covered instantly even if the next predicted channel is on another frequency. (Typically for example systems like TIVO already contain two tuners, in order to enable the user to view or record two programs at the same time). Of course, like other features of this invention, these features can be used also independently of any other features of this invention. Another possible variation is that for example the methods of digital compression are improved so that a base frame can be efficiently sent more often and/or each given frame is less dependent on the base frame. Of course various combinations of the above and other variations can also be used.

Although the above descriptions regarding recording Audio and/or Video in computers, with a Radio/Tape, and with a Videotape are described separately for clarity, almost any of the features described for one of them can be similarly used also with the other devices. In any of the above solutions if multiple tuners/decoders are used, one of the possible variations is that they are preferably integrated into a single circuit or chip (or for example a number of chips or circuits that support each more than one tuner), so that they can share at least part of their elements or for example at least part of their casing.

Of course, various copyright issues may be raised, but they can be easily solved for example by monthly subscriptions or for example some small payments for some of the data.

However, radio broadcasts exists already also over the Internet, and within a few years probably many Internet TV stations will also operate. Therefore, another possible variation is to use similar principles for example with radio or TV streaming data over the internet and/or cellular networks and/or other networks, for example with the aid of proxies dedicated for this, so that at least some proxies (for example proxies that are preferably at or near MAIN routers, which are preferably routers higher in a geographical hierarchy, for example as defined in Israeli application 139559 by the present author, submitted also as PCT application PCT/IL 01/01042, and/or for example special proxies dedicated to streaming data) are also able to keep streaming data for example in one or more circular buffers for a few minutes or even for example half an hour or more, and thus enable users also to request for example instant replay and/or retroactive recording even after the event has started. This is explained in more detail in the reference to FIG. 3.

On the other hand, for recording live events with a video camera, for example in a wedding or party or any other happenings with multiple participants, the idea of simply being able to retro-record events and thus not miss interesting unexpected happenings is simply not good enough yet, since the chance that what the user wants to retro-record was exactly in the range of the camera while the event happened is small. Therefore, video cameras with retro-record capability preferably contain much wider angles for example by using more than one CCD in a number of directions simultaneously, and/or using for example a wider fish-eye view or views which is preferably optically or digitally corrected to remove the distortions typical to such wider view cameras, so that any desired sections can later be saved with much less distortions, and/or using for example multiple cameras simultaneously that preferably cover as many angles as possible, or some combinations of the above. Another possible variation is that when more than one CCD is used, images at the borders between them that are on their periphery can be improved for example by digitally combining the images.

Another possible variation is to use similar principles for example with wrist watches or cellular phones or ordinary phones. This means that the watch or phone preferably contains within it at least one microphone and at least one preferably digital temporal buffer for example on flash memory or MRAM (Magnetic RAM which will be available in the next few years) and the user can record retroactively for example conversations for example if he decides that some important things have been said. In phones, preferably this can be used either for retroactively recording phone conversations or for recording sounds near the user, or a combination of the above. (This means of course that preferably at least two preferably circular buffers are used in parallel, one for constant automatic recording of phone conversations and one for constant automatic recording of sound in the environment, preferably with one or more non-directional microphones so that all directions can be recorded without problems. Like in the other examples, another possible variation is of course for example using one temporal buffer for both types of recording. Another possible variation is that the recording of incoming and outgoing phone conversations is automatically activated only when the phone conversation starts or when the phone line is open and/or if the recoding of external sounds is voice activated). This has of course the advantage that a watch or a cellular phone are very common electronic devices that users carry anywhere, and so they can be always available and also they can make the retroactive recording in an un-suspicious way, preferably without any indication to other people that recording is taking place. Another possible variation that can be used in any of the devices for retroactive recording is that the automatic recordings are voice activated, so that preferably periods of silence greater than a certain threshold are not recorded, thus saving space and increasing the useful size of the buffer and/or increasing the time until the battery needs to be recharged. Another possible variation is that the user can chose if he/she wants normal constant recording or only voice activated recording. Another possible variation, especially with digital recordings, is that the silences are also recorded but only logically, so that for example only the length of the silence is kept in memory so that the information is there but takes much less space. This can be useful for example for detectives if somebody suddenly says something very important, but many ordinary users can also benefit from it. Preferably the device contains one or more additional buffers for saving the data that the user decides he/she wants to keep, so that it is not overwritten by the controller of the temporal buffer, or for example the desired area is simply saved on the buffer itself by logically marking it not to be over-written, preferably until the user backs up the data on another device and/or until the users allows to release the mark. Afterwards preferably the user can transfer it for example to an ordinary tape or to a computer sound card for example through an audio plug in the watch or the normal audio plug that already exists if it is a cellular phone, or for example transmit it through Bluetooth or UWB or infra-red or any other known means for communication between electronic devices. Of course various combinations of the above and other variations are also possible.

### BRIEF DESCRIPTION OF THE DRAWINGS

FIGS. 1a-b are illustrations of preferable examples of a multi-tuner system enabling retroactive recording while zapping between channels.

FIG. 2 is an illustration of a preferable example of a single-tuner system enabling retroactive recording while zapping between channels, based on temporally saving one or more slices of the bandwidth itself.

FIG. 3 is an illustration of a preferable example of proxies on the Internet for saving multiple-source streaming data in temporal buffers.

### IMPORTANT CLARIFICATION AND GLOSSARY

All these drawings are just exemplary drawings. They should not be interpreted as literal positioning, shapes, angles, or sizes of the various elements. Throughout the patent whenever variations or various solutions are mentioned, it is also possible to use various combinations of these variations or of elements in them, and when combinations are used, it is also possible to use at least some elements in them separately or in other combinations. These variations are preferably in different embodiments. In other words: certain features of the invention, which are described in the context of separate embodiments, may also be provided in combination in a single embodiment. Conversely, various features of the invention, which are described in the context of a single embodiment, may also be provided separately or in any suitable sub-combination. Throughout the patent, including the claims, whenever a circular buffer or buffers are mentioned, it can mean interchangeably either single or plural, and it can be any type of buffer or files or memory areas for temporarily storing data, so this refers more to the logical concept than to any specific implementation. Throughout the patent, including the claims, when multi-tuners are mentioned it means preferably tuners/decoders, i.e. the parts that extract the appropriate part of the wave and decode the signal.

### DETAILED DESCRIPTION OF THE PREFERRED EMBODIMENTS

All of descriptions in this and other sections are intended to be illustrative examples and not limiting.

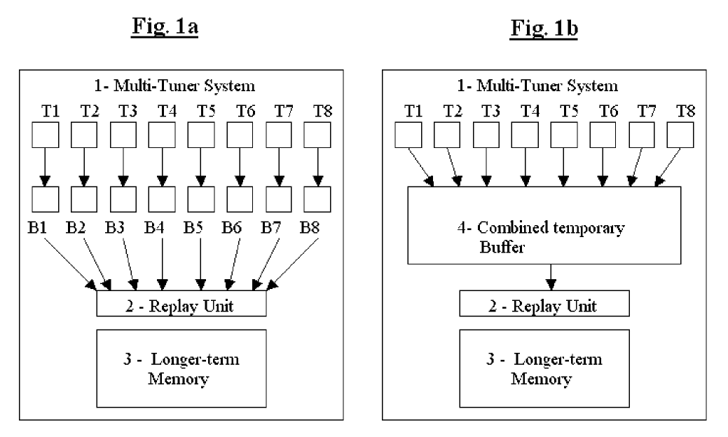

Referring to FIGS. 1a-b, I show illustrations of preferable examples of a multi-tuner system (1) enabling retroactive recording while zapping between channels. In this example there are 8 available tuners (marked as T1-T8), however this is only an example and of course any other convenient number can also be used. This system can be implemented for example in an Audio tape recorder, or in a Radio tuner or in a device which is a combination of the two, or for example in a Video Recorder, or in a computer, or in other devices. Each Tuner can be for example coupled to its own temporal buffer (marked as B1-B8), as shown in FIG. 1a. This has the advantage of more simplicity and less logic needed, however it has the disadvantage that the user can't divide the memory between the channels according to their importance to him/her. In the version shown in FIG. 1b all the tuners (T1-T8) are able to access the same memory device (4) and thus the user has much more flexibility in dividing the memory resources between the various channels, so that for example a channel such as Galgalatz, which the user may like more, gets more memory and thus enables retroactive recording for a longer period into the past (for example up to an hour), whereas another channel—for example Reshet Beth can be given for example a time limit of up to 15 minutes retroactive recording. The shared memory device can be used by the various tuners for example by using one or more temporal buffers, so that for example more than one tuners can share the same temporal buffer, or for example each tuner uses one or more buffers of its own, etc. To enable this preferably one or more microprocessors control the accesses to the common memory device. In both versions, if the user requests replay or retroactive recording of a certain channel, the data saved from it by the appropriate tuner is transferred to the replay unit (2) and/or to a longer term memory device (3), which can be for example MRAM or a hard disk or an Audio-Tape (either Analogue or Digital) or a Video-Tape (either analogue or digital) or CD or DVD, either coupled directly to the system (especially if the system itself is for example a PC with a Multi-tuner Sound card or Multi-tuner Video card), or residing for example in a PC and connected to the system for example through an audio input in the sound card, or any other means for transferring data between electronic devices. However, if a common buffer is used, another possible variation is for example to simply mark the area of the buffer containing the event that the user wants to save so that it is not rewritten, and letting the user transfer it to more permanent storage at a later time. If the tuners are analogue tuners, the decoded signals that come out from the tuners are preferably digitized before saving them in the temporal buffer or buffers. Another possible variation is that the carrier wave is for example digitized even before entering the tuners and the tuners are for example digital tuners, preferably integrated in one chip in order to make them cheaper. In the other direction, if it is for example a radio-tape system which is mostly analogue, another possible variation is to save the signals for example in analogue form within the temporal buffers, and preferably use D2A and A2d conversions where needed. Such analogue buffers may be implemented for example by using an analogue Magnetic RAM which can keep a wide range of analogue values in each cell. A multi-tuner system has the disadvantage that the user is limited to a given set of pre-specified channels, however this should be quite sufficient for most users since for example in a car radio there are typically 5-10 stations and the user rarely changes them to other channels, so a small number of tuners is enough. Similarly, in a Video coupled to a Cable TV or satellite TV receiver, out of maybe a 100 channels most users typically actually view most of the time only a much smaller number, such as for example the few most popular channels, plus a few movie channels plus a few music channels, etc, and ignore many other channels, such as for example channels in other languages, etc., so for example being able to specify a subset of 20 or 30 channels to cover might be quite satisfactory to most users. On the other hand it has the advantage that for example if the recording media is not serial such as a tape, preferably the user can easily record multiple sources simultaneously, for example two songs or programs at the same time. Another possible variation is that to further save costs, some of the features might be stripped of the tuners so that they conduct for example only the basic decoding of the signals out of the carrier waves, so that other features are conducted only later when needed. On the other hand, such an arrangement might make it more problematic to record more than one source at the same time. However, since users typically rarely record more than two programs at the same time, another possible variation is to have for example two parallel chips with the additional features, so that for example 8 cheap tuners are used, but only up to two separate programs can be recorded at the same time if they are longer than the time window (if they are shorter then the time window, for example two songs played on two different stations at more or less the same time, there is no problem to extract them from the buffer or buffers and save them serially). With Analog broadcasts typically each channel is broadcasted on a separate frequency or carrier wave. However, as explained above in the patent summary, if for example a single carrier wave is used (for example by a certain satellite radio station that broadcasts multiple channels) for sending more than one channel digitally for example by using time slices then another possible variation is that only a single tuner is needed, but by using this time slicing the digital data for more than one channel can be preferably extracted and saved in the temporary buffers, and thus even though only one tuner is used, there is no need to save the bandwidth itself or slices of it and still more than one channel can be covered simultaneously. (However, even in such a case the user will typically want to be able to cover also channels from other suppliers simultaneously, so multiple tuners are preferably used anyway). Alternatively, if a number of frequencies or carrier waves are used for digital broadcasts but each frequency or carrier wave contains more than one digital channel then preferably more channels can be covered than the number of tuners, so each tuner preferably can handle at the same time (by time slicing) saving the data from more than one channel in the temporal buffers. In this case, preferably after the user specifies the desired channels that he wishes to cover simultaneously for possible replay or retroactive recording, each tuner automatically handles the requested channels that are within the frequency or frequency range that it covers. Of course if the user wants to cover for example multiple such sources (for example different satellite providers), each of which uses more than one frequency, and each such frequency carrying multiple digital channels, then preferably at least one or more tuners are used for each such source as needed. Of course if the digital data is for example transmitted over the Internet, then it is like using a single frequency with multiple channels (typically based on packet switching), and typically the receiving device is a computer, so preferably in this case the computer uses one or more software that tunes in to multiple sources at the same time and continuously saves data from the covered channels in temporal buffers (Of course this can be also other devices that are connected to the Internet and not just a computer, such as for example powerful next generation cellular phones). For example the user might request to constantly cover a few dozen Internet Radio stations and one or more Internet TV stations, and in each one of them to cover for example one or more channels simultaneously. This continuous saving into the temporal preferably circular buffers can be done for example all the time that the computer is connected to the Internet and/or for example the user can preferably specify certain hours when one or more of the sources should be connected or disconnected, for example in order to keep the Internet connection less loaded. For example the user can preferably define that a certain internet radio station should be covered only a few hours each day, since these are the main hours that are usually interesting for him. On the other hand, constantly covering for example multiple Internet Radio stations and especially for example Internet TV stations, even with some hour limitations, can heavily burden the Internet connection and slow down any other internet activity, and in fact can be quite impractical with today's typical Internet connections, so this will be practical only when the Internet connections become with much more bandwidth and/or become much more efficient (for example by any of the methods described in PCT/IL 01/01042 or in PCT/IL 01/01075, filed by the present inventor). However, in the Internet or similar networks another possible variation is that replay and/or retroactive recoding is automatically available for example for various sources of streaming data even without support for this on the user's machine, for example by using proxies that support it and/or supporting it by the sources themselves, as explained in the reference to FIG. 3. Of course, various combinations of the above and other variations can also be used.

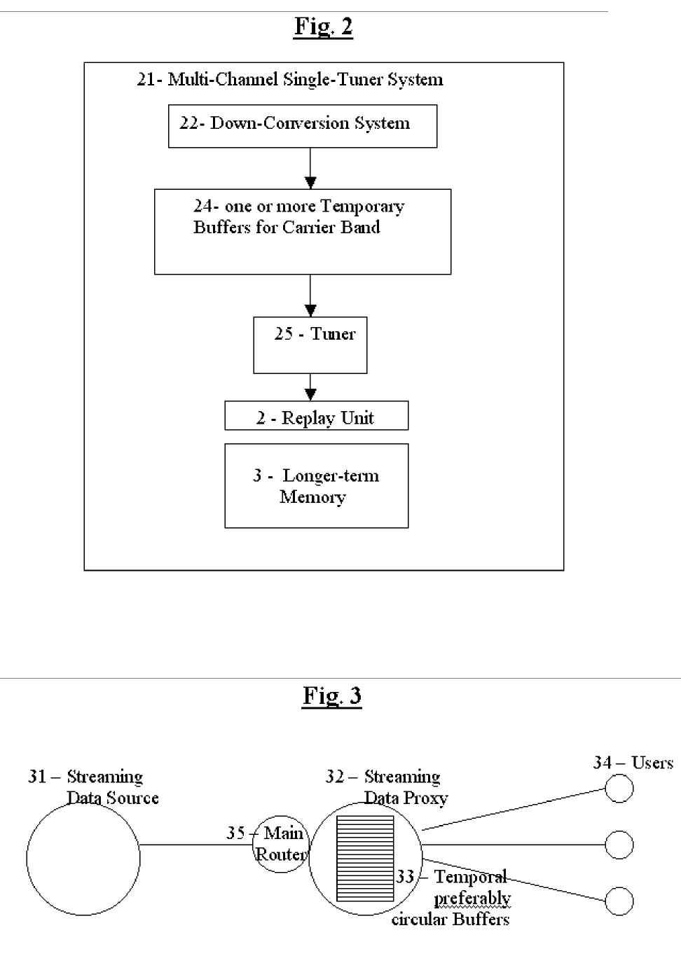

Referring to FIG. 2, I show an illustration of a preferable example of a single-tuner system (21) enabling retroactive recording while zapping between channels, based on temporarily saving one or more slices of the bandwidth of carrier waves. Each such slice is preferably first passed through a down-conversion system (22), so that for example if the needed range in a Radio system is 88 MHz up to 108 MHz, then the entire band can be converted for example to 1-20 MHz, so that it can be saved efficiently for example at a digital sampling rate of 40 MegaBytes per second. (The down-conversion is preferably based on deduction preferably without lowering the range itself, since narrowing the bandwidth with the down-conversion could cause various problems). These slices are then saved in one or more temporal buffers (24), preferably after down-conversion to lower frequency (22) and only when needed they are decoded by a tuner (25) and used for example with replay unit (2) or transferred to longer term memory (3). This system has the advantage that the user is not limited to designating channels in advance, however, if for example the channels are TV channels, there might be too much data to save, so the user might still be required to specify for example a few smaller sub-ranges. Another disadvantage is that it is less easy to record more than one program at the same time if the size of the programs is larger than the temporal window of the buffer. However, this can be solved for by using for example a CPU with time sharing that can simultaneously extract more than one channel from the carrier waves within the time limit. This is much easier if the system is implemented for example in a computer, and if the broadcasting itself is digital, for example by using already compressed data for example in MPEG2 or MPEG4 format, in which case the data is preferably saved as is in the compressed digital form, and the carrier-wave might be irrelevant or less important, as explained above in the patent summary and in the reference to FIG. 1a-b. For example if the data is broadcasted through the Internet and/or optically it may be irrelevant to talk about the carrier wave. However, if an encrypted signal is used, then the system can for example save the data from all the channels in one or more temporal buffers, preferably as-is, without decoding it, and then for example feed back the desired data to the decoder when needed. Another possible variation is to include for example more than one decoder, or a decoder that can handle more than one channel at a time (for example by multitasking or for example by global actions on the entire data stream), but that might require cooperation with the service provider, such as for example the Satellite Broadcasting service or the Cable TV provider. Another possible variation, if the signal is for example analogue and a decoder is needed, is to use for example two or more tuners, so that multiple channels are covered automatically but only for example two programs can be saved at the same time if they are longer than the time window. If the transmission is with one or more analogue carrier waves, one possible variation is to save them in analogue form, preferably after down-conversion in analogue form, and digitize them only if needed, after extracting the needed channel or channels. Another possible variation is for example to convert the bandwidth of carrier waves to digital form and down-convert it digitally (or for example first down-convert it analogically and the digitize it), save it digitally, and then, when needed, decode the needed channels also digitally (or for example convert it first back to analogue for decoding with a normal tuner). In short, various combinations of digital or analogue processing may be used, depending on convenience, price, desired quality, type of broadcast, etc. Of course, various combinations of the above and other variations can also be used.

Referring to FIG. 3, I show an illustration of a preferable example of using proxies on the internet for saving multiple-source streaming data in temporal preferably circular buffers, for use for example with Online Radio or TV stations. These proxies (32) are preferably at or near MAIN routers (35), which are preferably routers higher in a geographical hierarchy, for example as defined in PCT application PCT/IL 01/01042 by the present author, and/or for example special proxies dedicated to streaming data, and they are preferably able to keep streaming data for example in one or more circular buffers (33) for example for a few minutes or even for example half an hour or more, and thus enable users (34) also to request for example instant replay and/or retroactive recording even after the event has started. This way, for example if the user tunes in to an Internet Radio or TV station (31) and finds a fascinating program or song but has missed the start of it (or even if he/she hasn't missed the start but decides to record it only afterwards) or for example misses the start of a live lecture in a large scale video-conference or e-learning session, preferably he/she can request to replay and/or save a copy of it from the start of the program or event (as long as it is within the time window limit) and then the proxy can send the user the retroactive data. This way users can request for example instant replay and/or retroactive recording even if the user hasn't been tuned in to that streaming data or source before. When requesting any of these options preferably the user can either specify how many minutes ago to start the replay and/or retroactive recording, or for example request to jump back in a number of steps until he/she finds the start, or request to automatically go back to the start of the event, and in that case preferably the proxy can automatically identify the beginning of events, such as for example song or program (for example by content analysis but more preferably by a code which is broadcast along with each event and preferably identifies both the name and type of the event and its beginning and end). Another possible variation is that different time windows can be used for different events, preferably automatically (such as for example only up to a few minutes for a song and for example up to half an hour or more for TV programs or lectures). Another possible variation is that certain events for example carry also a code specifying the requested or recommended time window for that event, so that for example for more important events the proxies can be requested by the source of the streaming data to allow a longer retroactive time window. (A similar code can be used for example also in normal wireless Radio or TV transmissions for defining for example a recommended time window for each event and/or for each channel). Of course, another possible variation is that in addition or instead the sources of the streaming data themselves also keep such temporal buffers and similarly allow users to request instant replays up to a certain time limit after the start of events. Another possible variation is to allow the user for example to search the Internet for specific broadcasts, so that for example an RDS or other data signal that identifies for example a song name or for example a TV program can be simultaneously searched for example over a large number of Internet radio or TV systems, and the system can for example immediately alert the user when that song is played or the program or event is broadcasted and/or automatically start recording it into the temporal buffer so that it is immediately available for saving or replay. Another possible variation is to allow the replay in larger jumps, such as for example 15 or 30 minutes into the past, so that many users can view it at the same time, thus saving bandwidth for example when multiple identical packets going to the same physical direction are condensed into a single packet with multiple target addresses, as described for example in the above PCT application. Another possible variation is, like with the example of transferring large files in the above PCT application, that for example even if users don't want to start viewing at exactly the same time, requests for data can be combined even if some users start at a later point, and then for example only the missing starting parts are transferred separately to each user, preferably while at the same time the common parts are transferred simultaneously in condensed packets to many users in the same general area. Of course various combinations of the above and other variations are also possible.

While the invention has been described with respect to a limited number of embodiments, it will be appreciated that many variations, modifications, expansions and other applications of the invention may be made which are included within the scope of the present invention, as would be obvious to those skilled in the art.

1. A system that enables at least one of retroactive replay and retroactive recording of events after they have already started, even during switching between input channels.

2. The system of claim 1 wherein at least one of:
a. Said events are audio analogue broadcasts and said switching is zapping between channels;
b. Said events are audio digital broadcasts and said switching is zapping between channels;
c. Said events are analogue Video broadcasts and said switching is zapping between channels;
d. Said events are digital Video broadcasts and said switching is zapping between channels;
e. Said events are data streams over the Internet and said input channel are various sources of said data streams;
f. Said events are real world events in the vicinity of a video camera and the user can retroactively record events after they already started even if the camera was not directed specifically at the direction of said events;
g. The system is implemented within at least one of: A tape-recorder, a Videotape recorder, and A radio receiver;
h. Said events are streaming data over the Internet and a computer uses one or more software that enable the user to constantly cover simultaneously one or more sources of streaming data, and in each one of them to cover one or more channels simultaneously.

3. The system of claim 2 wherein said events are real world events in the vicinity of a video camera, and said retroactive recording is enabled by at least one of:
a. Using more than one CCD in different directions;
b. Using at least one wide-angle lens;
c. Using at least one fish-eye view and correcting it by at least one of optical or digital means to remove the distortions typical to such wider view cameras, so that any desired sections can later be saved with much less distortions.

4. (canceled)

5. The system of claim 2 wherein the system is a multi-tuner system, and the user can choose a given set of channels to cover, and the selected channels are automatically recorded into at least one temporal buffer, and at least one of the following features exist:
a. The tuners are simple decoders of the signal and any additional functions are performed only later if needed;
b. Multiple events can be recorded simultaneously if the user is interested in more than one event occurring at the same time;
c. The decoded signal is digitized before saving into the temporal buffer;
d. The signal is saved in analogue form in the temporal buffer;
e. The user defines in advance the size of the at least one temporal buffer;
f. The user can specify a different temporal buffer size for each channel;
g. The individual channels are decoded by analogue means;
h. The individual channels are decoded digitally;
i. If the channels are broadcasted digitally with encryption, they are at least one of: Decrypted before saving in the temporal buffers, and Encrypted later only if needed for replay and/or recording.

6. (canceled)

7. The system of claim 2 wherein at least one section of the bandwidth of carrier waves is saved on at least one temporary buffer before decoding the signals, and the signals are only decoded later if needed, and at least one of the following features exists:
a. The at least one section of the bandwidth is down-converted to a lower frequency before saving in the temporary buffer in order to save space;
b. More than one event can be saved at the same time by using a processor with time-sharing that extracts more than one channel within the time window and saves it before the buffer is overwritten;
c. The at least one section of the bandwidth of carrier waves is saved in digital form in the at least one temporal buffer;
d. The at least one section of the bandwidth of carrier waves is saved in analogue form in the at least one temporal buffer.

8. The system of claim 1 wherein at least one of the following exists:
a. The originator of the channel can add with it a code representing at least one of requested and recommended time window for said channel.
b. The system is implemented on a personal computer and the program auto-loads automatically whenever the user starts the computer, so that the user does not have to worry about forgetting to start the pre-recording;
c. At least one PC card is used for the tuner system;
d. At least one of the beginning of the event, its end, its type, and its name are included in a code coupled to the broadcasting of the event;
e. The event is recorded with compression, and said compression is done at least one of: 1; On the fly, while recording the event in the at least one temporal buffer, 2; Only when saving an event for longer time storage;
f. Each event is automatically saved in a temporary file with the event's name, and if the user wants to save it the file is simply moved to a permanent directory;
g. The user can request automatic volume normalization so that all songs are automatically set to approximately the same sound level, and the volume normalization is done at least one of: During saving to the compressed format and During playback;
h. Data that the user wants to save is copied to a separate buffer;
i. Data that the user wants to save is marked within its current area so that it will not be overwritten until the user allows it;
j. The recording into the temporary buffer is done also when the device is off, so that the retro-recording and replay features are available also when the user first starts the device;
k. At least one temporal buffer can be kept in at least one of: 1; At various transmitting stations along the way, and 2; At the center of the cable or satellite broadcasting;
l. Any user can request to replay at least one of the channels with a few possible pre-set time-lags so that many users can receive the replay at the same time;
m. If a single carrier wave is used and the data for various channels is sent digitally by using time slices then only a single tuner is needed but the digital data for more than one channel can be extracted and saved in the temporary buffers;
n. If a number of frequencies are used for digital broadcasts but each frequency contains more than one digital channels then each tuner can handle at the same time saving the data from more than one channel in the temporal buffers.

9. (canceled)

10. The system of claim 1 wherein the system clearly indicates to the user when he/she is “listening to the past”, and wherein at least one of the following features exists:
a. The system also indicates to the user also how long ago in the past the current playback is shifted;
b. When the event ends the system asks the user if he/she wants to switch back to real-time, and then the user can at least one of: Fast-forward into the present by fast discrete jumps, Fast forward into the present by fast replay at higher speeds, and Jump directly into the present;
c. When the user requests to stop listening in delayed mode, the system asks the user if he/she wants to switch back to real-time, and then the user can at least one of: Fast-forward into the present by fast discrete jumps, Fast forward into the present by fast replay at higher speeds, and Jump directly into the present.

11. The system of claim 1 wherein the events are streaming data over the internet and/or cellular networks and/or other networks, and at least some proxies use temporal buffers to enable users also to request instant replay even after the event has started, and even if the user has not been at all tuned to the event when it started.

12. The system of claim 11 wherein at least one of the following features exist:
a. Said proxies are proxies dedicated for streaming data;
b. Said proxies are near Main routers, which are routers higher in a geographical hierarchy;
c. Replay is allowed in a few discrete time shifts, so that many users can view it at the same time, thus saving bandwidth when multiple identical packets going to the same physical direction are condensed into a single packet with multiple target addresses;
d. Requests for data can be combined even if some users start at a later point, and then only the missing starting parts are transferred separately to each user, while at the same time the common parts are transferred simultaneously in combined packets to many users in the same general area.

13. The system of claim 1 wherein the user can at least one of:
a. Specify how many minutes ago to start at least one of the replay and/or retroactive recording;
b. Request to jump back in a number of steps until he/she finds the start;
c. Request to automatically go back to the start of the event.

14. The system of claim 1 wherein the system is implemented in at least one of a phone, a cellular phone, and a wrist watch, and wherein the system can retroactively record conversations without indicating to other people that the recording is going on.

15. The system of claim 14 wherein at least one of the following features exist:
a. At least one of conversations over the phone and conversations physically near the phone can be recorded retroactively;
b. At least two buffers are used in parallel, one for automatic recording of phone conversations and one for automatic recording of sound in the environment;
c. The automatic recording of phone conversations is activated only when the phone line is open;
d. The automatic recording of phone conversations is active all the time.
e. The automatic recordings are voice activated, so that periods of silence greater then a certain threshold are not recorded, thus saving space and increasing the useful size of the at least one temporal buffer;
f. The user can chose if he/she wants normal constant recording or voice activated;
g. The silences are also recorded but only logically, so that the length of the silence is kept in memory.

16-30. (canceled)

31. The system of claim 1 wherein the retroactive recording is in a car radio and in order to increase the battery life at least one of the following features exists:
a. The car can automatically activate the engine for a short time after the battery is low below a certain threshold, in order to recharge the battery;
b. The user can program the device to be recording into the circular buffer in off-mode only during certain hours;
c. The system automatically keeps statistics of the main times that the user activates the device and automatically activates it to record in off-mode only in the relevant times where it is most likely that the user might need it;
d. The recording into the circular buffer is automatically voice-activated;
e. The automatic recording into the circular buffer automatically starts only when the user enters the car and/or starts the engine;
f. The automatic recording into the circular buffer automatically stops after the user has turned off the radio and/or turned off the engine.

32. The system of claim 1 wherein a digital radio and/or video station broadcasts the data at a faster than the normal listening rate, and at least one of the following features exists:
a. The faster broadcast is repeated automatically again and again;
b. The faster broadcast is repeated automatically again and again, and each re-broadcast sends the next N minutes in the shorter time that it takes regardless of round-hour borders and/or of program-end borders;
c. The faster broadcast includes also recent past-data.

33. The system of claim 1 wherein the system gathers automatically statistics about the user's viewing habits and can automatically decide which channels to cover automatically for retroactive viewing and/or what should be the best retroactive time window allocated to each channel.

34. The system of claim 33 wherein at least one of the following features exists:
a. In channels in which the user typically spends more time and/or in which the typical program size is longer the time window can be automatically set to longer;
b. This can be done in combination with manual user definitions, so that the user can view and edit or improve the automatically generated definitions of channels and/or of retroactive window time-length to cover, and/or the user can define the channels and/or the time windows initially and then the system automatically adjusts it afterwards according to the usage statistics;
c. The system can adjust the definitions of channels and/or of timw windows within certain limits, so that the system cannot make drastic changes beyond a certain level without warning the user or asking the user for authorization;
d. If multiple users are using the same device then the user can identify himself/herself through the remote control or by other means or can be identified automatically by the system and then automatically the user's personal definitions become effective and/or his/her specific statistics are used;
e. The statistics can be used for the entire family on an average basis;
f. The system also takes into account also statistics about the usual times that each user typically watches the TV and thus can automatically switch the retroactive channels and/or time lengths in advance even a certain time before the user is expected to change.

35. The system of claim 1 wherein features that are used for retroactive recording can be used also for improved speed of normal zapping, so that when the user zaps into another channel the system can automatically supply the last base-frame and its following sequence, so that the system can instantly start showing the video stream of the newly zapped-into channel without unnecessary delays and without having to wait for the next base frame.

36. The system of claim 35 wherein this can be combined with heuristics based on user behavior statistics, so that if the user typically zaps between certain stations in a certain sequence or at least in a certain set or group or sets or groups this can be automatically taken into account even if any of the newly predicted zaps are not currently covered for retroactive recording, and/or when the user simply zaps forwards or backwards in a sequence then the system can automatically generate retroactive recording, even for a short time window, for the predicted next jump or jumps.

37. A system for improved zapping speed between digital TV channels comprising: A system for predicting in advance which channel or channels the user is most likely to jump to next, and A system for looking ahead in the predicted channel or channels for the required data stream.

38. The system of claim 37 wherein at least one of the following features exists:
a. The system contains at least two or more tuners, so that apart from the tuner that is currently used for the currently viewed channel, the other tuner or tuners are automatically used to keep track of the base frame and/or its following current frames and/or other needed data stream in the channel or channels which the system predicts that the user is most likely to zap to next;
b. If more then one predicted channel reside on the same base frequency then the system can automatically update multiple buffers at the same time, so that on each frequency the tuner (and/or other elements in the system) can save at least the minimal amount of needed data for all the channels of that frequency or at least for the most predicted channels of that frequency, and/or at least the current frame and/or base frame of each channel can preferably be saved there;
c. Each tuner has multiple processors or ASICS which can work in parallel for better efficiency;
d. The digital channels are arranged in advance by the channels supplier, so that the channels on each carrier frequency are consecutive, since the user is most likely normally to zap between consecutive or at least near channels, and then this way fewer tuners can be enough for covering multiple predicted next-zap channels.
